(19) United States
(12) Patent Application Publication
(10) Pub. No.: US 2007/0030993 A1
(43) Pub. Date: Feb. 8, 2007

(54) Monitor apparatus

(75) Inventor: Suk-ju Yun, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/496,518

(22) Filed: Aug. 1, 2006

(30) Foreign Application Priority Data
Aug. 5, 2005 (KR) 2005-71935

(51) Int. Cl. H04R 1/02

(52) U.S. Cl. 381/388

(57) ABSTRACT

A monitor apparatus, including a base; a display to display images; a stand to connect the display and the base; a first speaker unit provided in the base to face forward and output audio signals of a first channel; a second speaker unit provided in the base to face forward and spaced away from the first speaker unit and to output audio signals of a second channel; and a rear speaker unit provided in a rear portion of the base to output audio signals of a channel different from the first channel and the second channel. Also provided with the monitor apparatus is a speaker to reproduce mid-to-low-pitched sounds, thereby producing three-dimensional sounds with improved sound quality.

### CROSS-REFERENCE TO RELATED APPLICATIONS

This application claims priority from Korean Patent Application No. 2005-0071935, filed on August 5, in the Korean Intellectual Property Office, the disclosure of which is incorporated herein in its entirety and by reference.

### BACKGROUND OF THE INVENTION

1. Field of the Invention

The present general inventive concept relates to a monitor apparatus, and more particularly, to a monitor apparatus having an improved speaker assembly.

2. Description of the Related Art

In general, a monitor apparatus includes a base placed on an installation surface, a stand connected to the base and a display coupled to the stand to display images.

Recently, as technologies advance for a device having multi-functions, a monitor apparatus capable of producing sounds as well as displaying images has been, and continues to be developed.

For example, in Korean First Publication Patent No. 2000-0036412, a liquid crystal display monitor is disclosed, which includes a liquid crystal panel, a casing supporting the liquid crystal panel, a speaker disposed in the casing, a stand supporting the case and a diffuser coupled to the stand to enhance low-pitched sounds reproduced in the speaker. In this monitor, when sounds are reproduced in the speaker, the volume of the sounds is increased due to a sound reflection function of the diffuser.

However, increasing the low-pitched sounds by using the diffuser, which reflects the sounds reproduced in the speaker, has a limit to improving sound quality and producing three-dimensional sounds.

### SUMMARY OF THE INVENTION

Accordingly, the present general inventive concept provides a monitor apparatus having a speaker to reproduce mid-to-low-pitched sounds, thereby producing three-dimensional sounds with improved sound quality.

Additional features of the present general inventive concept will be set forth in the description which follows, and in part will be apparent from the description, or may be learned by practice of the general inventive concept.

The foregoing and/or other aspects and utilities of the present general inventive concept can be achieved by providing a monitor apparatus, comprising: a base; a display to display images; a stand to connect the display and the base; a first speaker unit provided in the base to face forward and output audio signals of a first channel; a second speaker unit provided in the base to face forward and be spaced away from the first speaker unit and to output audio signals of a second channel; and a rear speaker unit provided in a rear portion of the base and to output audio signals of a channel different from the first channel and the second channel.

The rear speaker unit may comprise a woofer speaker to output woofer signals (i.e., mid-to-low-pitched sounds).

The woofer unit may comprise a woofer main body disposed to be exposed outside of a rear portion of the base and to output the woofer signals, and a connection part provided on the woofer main body to be coupled to the base.

The base may be formed with a through-hole in a rear portion thereof for connection with the connection part, and the connection part may be formed with a fixing hole to which a screw inserted into the through-hole is fastened.

The monitor apparatus may further comprise a speaker cover provided at the base and to cover the first speaker unit and the second speaker unit so that the first speaker unit and the second speaker unit are not exposed to an outside, and wherein the first speaker unit and the second speaker unit are disposed at an inside of the base.

The foregoing and/or other aspects and utilities of the present general inventive concept can also be achieved by providing a base to support an audio/video apparatus, comprising: a base portion to be disposed on a surface; a stand portion pivotally connected to the base portion to support a video unit; a first speaker unit provided in the base portion to face forward and output audio signals of a first channel; a second speaker unit provided in the base portion to face forward and be spaced away from the first speaker unit by a predetermined distance and to output audio signals of a second channel; and a third speaker unit provided at a rear portion of the base portion and to output audio signals of a channel different from the first channel and the second channel.

The foregoing and/or other aspects and utilities of the present general inventive concept can also be achieved by providing a support apparatus used with a monitor, comprising: a base; a stand pivotally connected to the base to support the monitor; a first speaker unit provided in a left side of the base and at a first side of the stand to face forward and to output audio signals of a first channel; a second speaker unit provided in a right side of the base and at another side of the stand opposite to the first side to face forward and to output audio signals of a second channel; and a mounting part extending along a rear portion of the base and at a third side of the stand to securely accommodate a third speaker unit that outputs audio signals of a channel different from the first channel and the second channel.

The foregoing and/or other aspects and utilities of the present general inventive concept can also be achieved by providing a support apparatus used with a monitor, comprising: a base including two speakers disposed therein and facing forward to output audio signals from two different channels; a stand pivotally connected to the base between the two speakers to support the monitor; and a tubular member connected to a rear portion of the base and behind the stand to emit audio signals of a third channel such that the first, second and third channels provide a three-dimensional sound.

It is to be understood that both the foregoing general description and the following detailed description are exemplary and explanatory and are intended to provide further explanation of the present general inventive concept as claimed.

### BRIEF DESCRIPTION OF THE DRAWINGS

The above and/or other aspects and advantages of the present general inventive concept will become apparent and more readily appreciated from the following description of the exemplary embodiments, taken in conjunction with the accompany drawings, in which:

FIG. 1 is a perspective view of a monitor apparatus according to an embodiment of the present general inventive concept;

FIG. 2 is a perspective view of a stand, a base and a woofer unit of the monitor apparatus according to an embodiment of the present general inventive concept, which are coupled to each other;

FIG. 3 is an exploded perspective view of the monitor apparatus in FIG. 2;

FIG. 4 is a perspective view of the woofer unit of FIGS. 2 and 3;

FIG. 5 is a bottom view illustrating a state in which the woofer unit is coupled to an upper casing of the base; and

FIG. 6 is a bottom view illustrating the state in which a lower casing is coupled to the upper casing to which the woofer unit is coupled as illustrated in FIG. 5.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

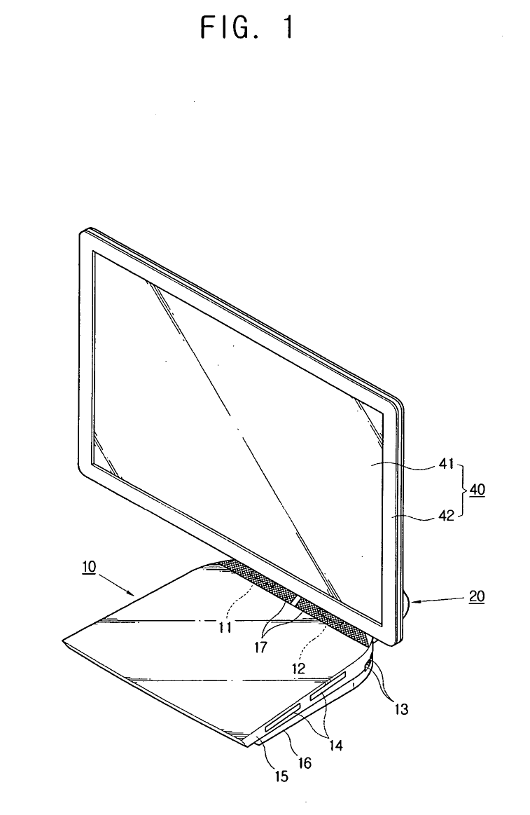

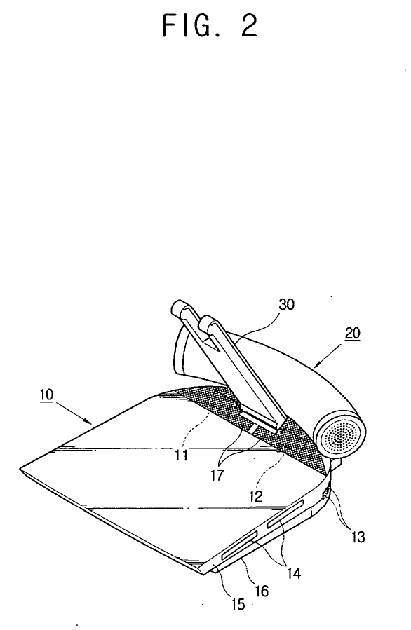

As illustrated in FIGS. 1 and 2 a monitor apparatus according to an embodiment of the present general inventive concept includes a base 10 disposed on an installation surface; a display 40 having a display panel 41 to display an image and an outer casing 42 to support the display panel 41; and a stand 30 rotatably coupled to the display 40 at one end thereof and rotatably coupled to the base 10 at the other end thereof to connect the display 40 and the base 10.

As illustrated in FIG. 2, the base 10 is provided with a left speaker unit 11 to output audio signals of a L (left) channel, a right speaker unit 12 to output audio signals of a R (right) channel, and a woofer unit 20 as a rear speaker to output woofer signals (i.e., mid-to-low-pitched sounds).

The left speaker unit 11 and the right speaker unit 12 are illustrated as being mounted in a left and a right side of the base 10, respectively, so as to be spaced away from each other by a predetermined distance and to face forward. The woofer unit 20 is illustrated as being coupled to the base 10 so as to be located at a rear side of the stand 30.

The base 10 is provided with various ports 13 for connection with various equipments including a computer, and external device mounting parts 14 on which external devices can be mounted.

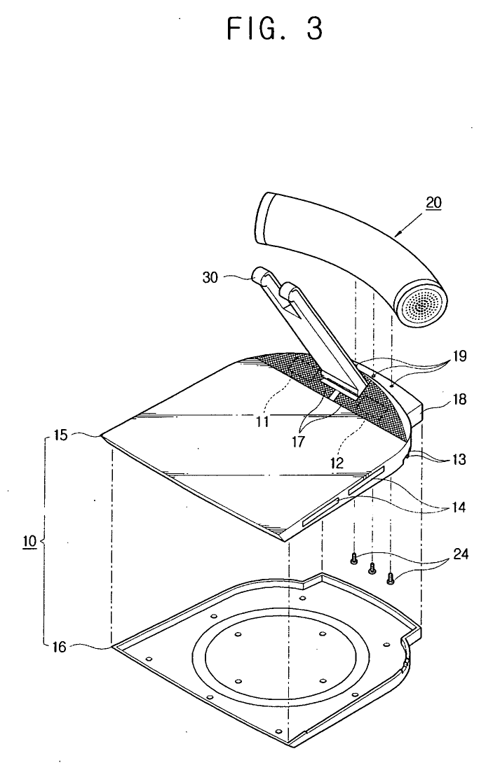

As illustrated in FIG. 3, the base 10 is provided with an upper casing 15 and a lower casing 16, which combine with each other to provide an empty inner space to install various hardwares therein. In FIG. 3, the various hardwares that can be installed in the inner space formed by the upper casing 15 and the lower casing 16 are not illustrated for simplicity of description of the general inventive concept.

On an upper surface of the upper casing 15, a speaker cover 17 is attached to cover the left speaker unit 11 and the right speaker unit 12. In a rear side of the upper casing 15, a woofer mounting part 18, to which the woofer unit 20 is coupled, is provided.

The woofer mounting part 18 of the upper casing 15 can be formed with a plurality of through-holes 19 to allow screws 24 to pass through to fasten the woofer unit 20 thereto. However, the general inventive concept is not limited to using screws, but can use any connecting device to fasten the woofer unit 20 to the upper casing 15, which provides the intended purpose as described herein.

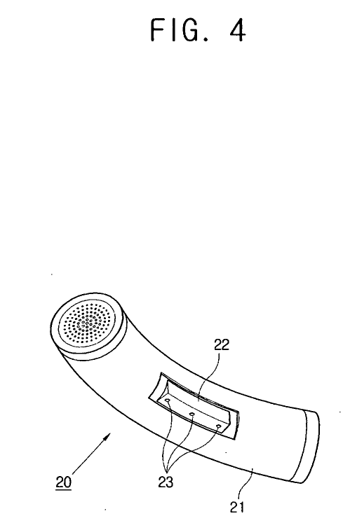

As illustrated in FIGS. 3 and 4, the woofer unit 20 is to emphatically reproduce mid-to-low-pitched sounds of the audio frequency range, and includes a woofer main body 21 to output the woofer signals and a connection part 22 formed on the woofer main body 21 to connect the woofer main body 21 to the woofer mounting part 18 of the base 10.

As illustrated in FIG. 4, the connection part 22 can be formed with fixing holes 23 corresponding to the through-holes 19 formed in the woofer mounting part 18 of the base 10.

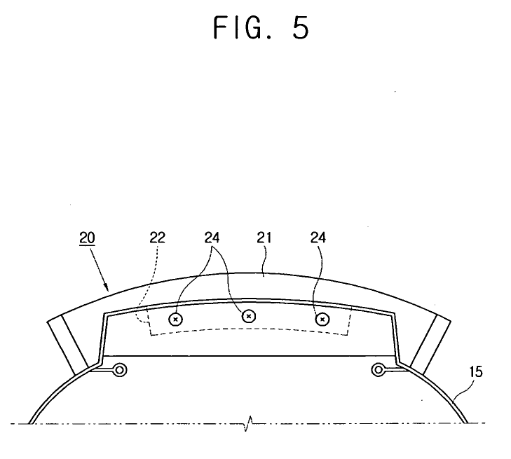

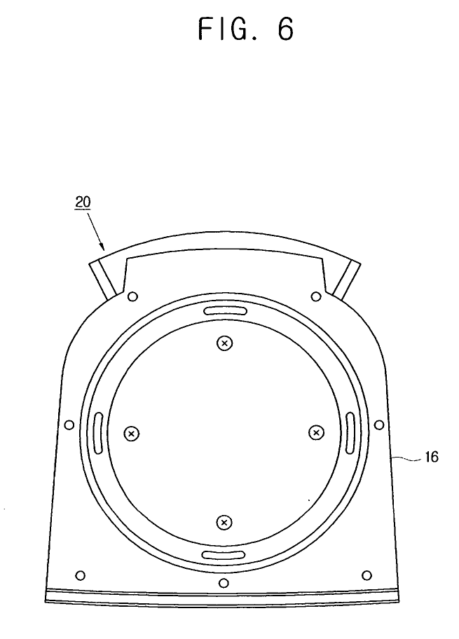

Hereinafter, a method of connecting the woofer unit 20 to the upper casing 15 will be described. First, the connection part 22 of the woofer unit 20 is brought into close contact with the woofer mounting part 18 of the upper casing 15 so that the fixing holes 23 of the woofer unit 20 communicate with the through-holes 19 of the upper casing 15. Then, as illustrated in FIG. 5, the screws 24 are screwed into the fixing holes 23 of the connection part 22 after being inserted into the through-holes 19 of the upper casing 15 in a direction from an inside to an outside of the upper casing 15 so that heads of the screws 24 are disposed at the inside of the upper casing 15. Next, as illustrated in FIG. 6, the lower casing 16 is coupled to a lower side of the upper casing 15, thereby completing the process of connecting the woofer unit 20 to the base 10.

As described above, since the monitor apparatus according to the present general inventive concept includes the woofer unit 20 to emphatically reproduce mid-to-low-pitched sounds as well as the left speaker unit 11 for the L channel and the right speaker unit 12 for the R channel, it can produce high quality three-dimensional sounds.

Meanwhile, in the above described embodiments of the present general inventive concept, the rear speaker unit is illustrated as being constituted by a woofer unit. However, the present general inventive concept is not limited thereto, and may alternatively be constituted by, for example, a speaker for a C (center) channel to output audio signals of the center channel, a speaker of a rear L (left) channel or a speaker of a rear R (right) channel.

As described above, according to the present general inventive concept, there is provided a monitor apparatus which is capable of producing high quality three-dimensional sounds.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A monitor apparatus, comprising:
a base;
a display to display images;
a stand to connect the display and the base;
a first speaker unit provided in the base to face forward and to output audio signals of a first channel;
a second speaker unit provided in the base to face forward and be spaced away from the first speaker unit and to output audio signals of a second channel; and
a rear speaker unit provided in a rear portion of the base and to output audio signals of a channel different from the first channel and the second channel.

2. The monitor apparatus according to claim 1, wherein the rear speaker unit comprises a woofer speaker to output woofer signals.

3. The monitor apparatus according to claim 2, wherein the woofer unit comprises a woofer main body disposed to be exposed outside of a rear portion of the base and to output the woofer signals, and a connection part provided on the woofer main body to be coupled to the base.

4. The monitor apparatus according to claim 3, wherein the base is formed with at least one through-hole in a rear portion thereof for connection with the connection part, and the connection part is formed with at least one fixing hole to which a respective screw inserted into a respective one of the at least one through-hole is fastened.

5. The monitor apparatus according to claim 1, further comprising a speaker cover provided at the base to cover the first speaker unit and the second speaker unit so that the first speaker unit and the second speaker unit are not exposed to an outside, and
wherein the first speaker unit and the second speaker unit are disposed at an inside of the base.

6. The monitor apparatus according to claim 2, further comprising a speaker cover provided at the base to cover the first speaker unit and the second speaker unit so that the first speaker unit and the second speaker unit are not exposed to an outside, and
wherein the first speaker unit and the second speaker unit are disposed at an inside of the base.

7. The monitor apparatus according to claim 3, further comprising a speaker cover provided at the base to cover the first speaker unit and the second speaker unit so that the first speaker unit and the second speaker unit are not exposed to an outside, and
wherein the first speaker unit and the second speaker unit are disposed at an inside of the base.

8. The monitor apparatus according to claim 4, further comprising a speaker cover provided at the base to cover the first speaker unit and the second speaker unit so that the first speaker unit and the second speaker unit are not exposed to an outside, and
wherein the first speaker unit and the second speaker unit are disposed at an inside of the base.

9. The monitor apparatus according to claim 1, wherein the base comprises an upper casing and a lower casing that combine together to form an empty space therebetween to install electronic hardware, the upper casing including at least one through-hole to accommodate screws to extend through from a bottom part thereof to a top part thereof to connect the rear speaker to the base.

10. The monitor apparatus according to claim 9, wherein the upper casing comprises a mounting part extending along a rear portion thereof to accommodate the at least one through-hole.

11. The monitor apparatus according to claim 10, wherein the rear speaker unit comprises a connection part to be coupled to the at least one through-hole.

12. A base to support an audio/video apparatus, comprising:
a base portion to be disposed on a surface;
a stand portion pivotally connected to the base portion to support a video unit;
a first speaker unit provided in the base portion to face forward and output audio signals of a first channel;
a second speaker unit provided in the base portion to face forward and be spaced away from the first speaker unit by a predetermined distance and to output audio signals of a second channel; and
a third speaker unit provided at a rear portion of the base portion and to output audio signals of a channel different from the first channel and the second channel.

13. The base according to claim 12, wherein the base portion comprises a mounting part extending along a rear portion thereof and provided with through-holes therein to accommodate connection members to extend therethrough and connect the third speaker unit to the base portion.

14. The base according to claim 13, wherein the base portion includes several ports to provide connection locations for external electronic equipments.

15. The base according to claim 12, wherein the third speaker is a woofer to project mid-to-low-pitched sounds of an audio frequency range.

16. A support apparatus used with a monitor, comprising:
a base;
a stand pivotally connected to the base to support the monitor;
a first speaker unit provided in a left side of the base and at a first side of the stand to face forward and to output audio signals of a first channel;
a second speaker unit provided in a right side of the base and at another side of the stand opposite to the first side to face forward and to output audio signals of a second channel; and
a mounting part extending along a rear portion of the base and at a third side of the stand to securely accommodate a third speaker unit that outputs audio signals of a channel different from the first channel and the second channel.

17. The support apparatus according to claim 16, wherein the mounting part includes a plurality of through-holes to receive connecting members extending from a third speaker unit.

18. The support apparatus according to claim 17, wherein the mounting part extends along the rear portion of the base from at least the first speaker unit to the second speaker unit to accommodate the third speaker unit.

19. The support apparatus according to claim 18, further comprising:
a tubular type third speaker unit that is removably connected to the mounting part and acoustically compliments the output audio signals of the first and second speaker units.

20. A support apparatus used with a monitor, comprising:
a base including two speakers disposed therein and facing forward to output audio signals from two different channels;
a stand pivotally connected to the base between the two speakers to support the monitor; and
a tubular member connected to a rear portion of the base and behind the stand to emit audio signals of a third channel such that the first, second and third channels provide a three-dimensional sound.

22. The support apparatus according to claim 20, wherein the tubular member is a woofer speaker to output mid-to-low-pitched sounds.
